(19) United States
(12) Patent Application Publication
(10) Pub. No.: US 2011/0174133 A1
(43) Pub. Date: Jul. 21, 2011

(54) Headstock for Altering Tonal Quality of a Stringed Instrument

(76) Inventors: Paul Unkert, Toms River, NJ (US); Jorn Gorlach, Manchester, NJ (US)

(21) Appl. No.: 13/006,543

(22) Filed: Jan. 14, 2011

Related U.S. Application Data
(60) Provisional application No. 61/295,243, filed on Jan. 15, 2010.

(51) Int. Cl. G10D 3/00

(52) U.S. Cl. 84/293

(57) ABSTRACT

The present invention features a headstock which changes the tonal quality of a stringed instrument. Specifically, the headstock of this invention contains one or more slots thereby generating independently resonating arms to which the strings are anchored. In this regard, the resonance of the string is dependent upon the resonance of the arm.

### INTRODUCTION

This application claims the benefit of U.S. Provisional Application No. 61/295,243 filed Jan. 15, 2010, which is herein incorporated by reference in its entirety.

### BACKGROUND OF THE INVENTION

The guitar, in one form or another, is one of the most popular musical instruments in use today and is used in a plethora of musical genres. Luthiers strive to produce the best sounding guitars that they can. To accomplish this they must build guitars that emanate tones (notes) pleasant to the ear, and that produce maximum sound amplification. Sound is any change in air pressure that our ears can perceive. Pleasant sound is generally known as the tones or notes of the major and minor scales. These notes are denoted by the frequency of oscillation that causes the change in air pressure that our ears perceive as that note.

A tonal quality is distinguished as clear (or “true”) when the ear perceives a solo frequency of oscillation or a combination of a very small number of related frequencies of oscillation (harmonics) rather than a combination of hundreds of random frequencies of oscillation. The generation of good tonal quality can be a function of several elements such as the materials of construction of the body; the volume, the shape and taper of the body; as well as the configuration of the upper and lower bouts.

In this regard, various approaches have been taken to improve the sound of stringed instruments including use of a harmonic bridge (U.S. Pat. Nos. 7,301,085 and 7,166,788), a soundboard made of a three ply torsion box design utilizing a honeycomb substrate as the central core (U.S. Pat. No. 7,342,161), a compliantly suspended sound board (U.S. Pat. No. 6,646,190), and an adjusting device for adjusting the neck curvature (U.S. Pat. No. 6,399,862). In another approach, U.S. Pat. No. 6,563,032 discloses a multi-plane headstock to which the strings of a stringed musical instrument may be attached to control string tension and the angle at which the string breaks from the plane of the strings over the fingerboard.

### SUMMARY OF THE INVENTION

The present invention features a headstock composed of two or more slots therein thereby creating two or more independent arms, wherein at least one of the independent arms has one or more string anchor components. In one embodiment, the string anchor components are tuning machines. In another embodiment, the two or more independent arms have symmetrical features. In an alternative embodiment, the two or more independent arms have asymmetrical features including one or more of (a) arm thickness, (b) arm width, (c) arm length, (d) shape of arm, (e) location of arms, (f) orientation of arms, (g) construction material of arms, (h) location of string anchor components, (i) number of string anchor components, and (j) construction material of string anchor components. Stringed instruments containing the headstocks of the invention are also provided.

The present invention also features a method for altering tonal quality of a stringed instrument. In accordance with this method, a slot is inserted into the headstock of the stringed instrument thereby generating at least two arms in the headstock, and a string anchor component is attached to at least one of the arms thereby altering the tonal quality of the string and stringed instrument.

### BRIEF DESCRIPTION OF THE DRAWINGS

FIG. 1 is a front view of headstock of the present invention containing two slots. FIG. 1A depicts asymmetrical string anchor components. FIG. 1B depicts asymmetrical string anchor component location.

FIG. 2 shows front views of headstocks containing two slots originating from one (FIG. 2A) or both sides (FIG. 2B) of the headstock.

FIG. 3 depicts a distal end view (FIG. 3A) and front view (FIG. 3B) of a headstock containing two slots originating from the side of the headstock.

FIG. 4 depicts a side view (FIG. 4A) and front view (FIG. 4B) of a headstock containing two slots originating from the distal end of the headstock.

FIG. 5 shows front views of headstocks with symmetrical (FIG. 5A) and asymmetrical (FIG. 5B) arms.

FIG. 6 is a front view of a headstock with five arms.

FIG. 7 is a front view of a headstock with six arms and six string anchor components.

FIG. 8 is a front view of a headstock with six arms and 12 string anchor components.

FIG. 9 is a front view of a headstock with three arms, and five string anchoring components, wherein two of said anchoring components are affixed to the base of the headstock.

FIG. 10 shows distal end views headstocks with arms of different thicknesses (FIG. 10A) and different shapes (FIG. 10B).

FIG. 11 is a front view of a headstock with three arms wherein the location of the arms on the base is asymmetrical.

FIG. 12 is a side view of a headstock with three arms wherein the orientation of the arms is asymmetrical, i.e., the arms have different planes with respect to each other and the base.

### DETAILED DESCRIPTION OF THE INVENTION

The “voice” any particular stringed instrument has is based on its design and construction. The present invention relates to a stringed instrument that derives tonal quality from the headstock. As is conventional in the art, a headstock is the part of a stringed instrument that anchors the instrument's strings. Strings go from the bridge, over the nut, and are usually fixed on machine heads or tuning machines on the headstock. While conventional headstocks are composed of a solid, continuous surface or mass to which all strings are anchored, the instant headstock contains a discontinuous surface for anchoring the strings. The discontinuous surface is created by slots cut into the headstock thereby creating digits or arms to which all or some of the strings are anchored. Because each arm can move or resonate independently from other arms, the resonance of strings anchored to the arms is altered. In this regard, the resonance of each individual string, combination of strings and/or instrument can be modified to improve or optimize the tonal of each string, as well as chords or scales.

For reference, the portion of the headstock attached to the neck will be referred to herein as the proximal end of the headstock, whereas the portion of the headstock farthest from the neck will be referred to as the distal end of the headstock. In addition, the front of the headstock will refer to the side of the headstock continuous with the fingerboard.

For illustrative purposes, a guitar-style stringed musical instrument is exemplified herein, however, the present invention can be utilized in many acoustic, electric, or semi-acoustic stringed instrument designs, including the guitar family of instruments in some embodiments, i.e., guitars, bass guitars, banjos, sitars, mandolins, ukuleles, “Chapman” sticks, Pikasso guitars (i.e., 4 necks, 2 sound holes, 42 strings) and the like; and viol family of instruments in other embodiments, i.e., violins, violas, cellos, basses, lutes and the like.

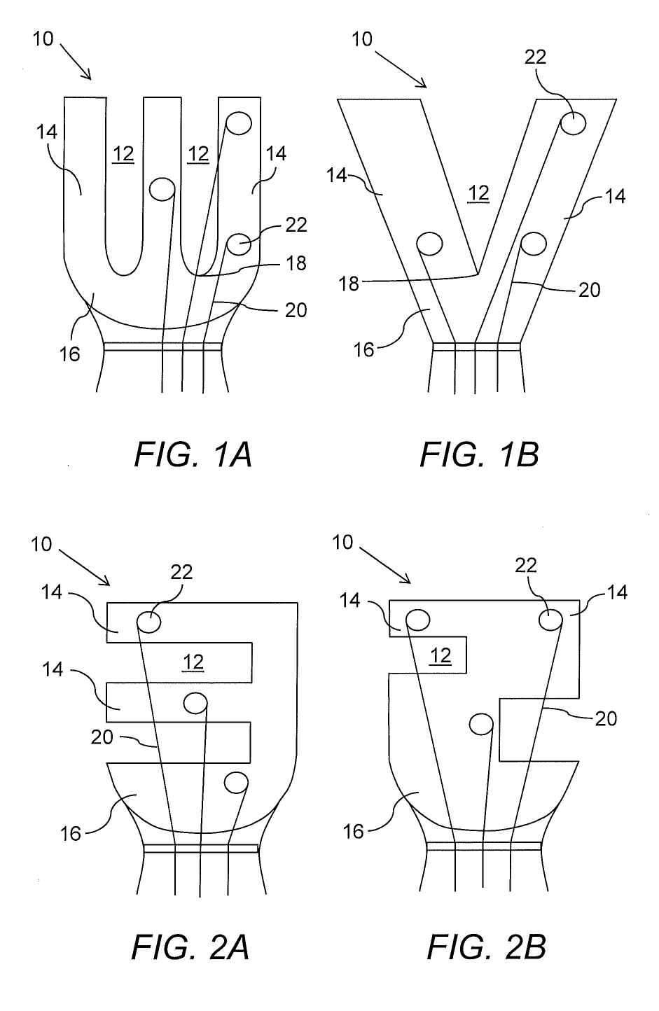

According to one embodiment, the present invention embraces a headstock 10 containing at least two slots 12 therein, thereby generating at least two independent arms 14 (FIG. 1A). According to the invention, an arm is a structure that can resonate independently from another arm. An arm is defined as being independent when it has no direct physical connection to another arm except through the base 16. As a point of reference, the deepest point 18 of a slot 12 demarcates the arm 14 from the base 16. When desired, string(s) 20 is attached to an arm 14 of the headstock 10 via string anchor component 22. When struck or plucked, the resonance of the strings 20 will be dependent upon the independent movement or resonance of the independent arms 14 to which the strings 20 are anchored. Advantageously, the independent resonance of the arms 14 provides for the alteration of tonal quality of each independent string that is not achievable with conventional headstocks.

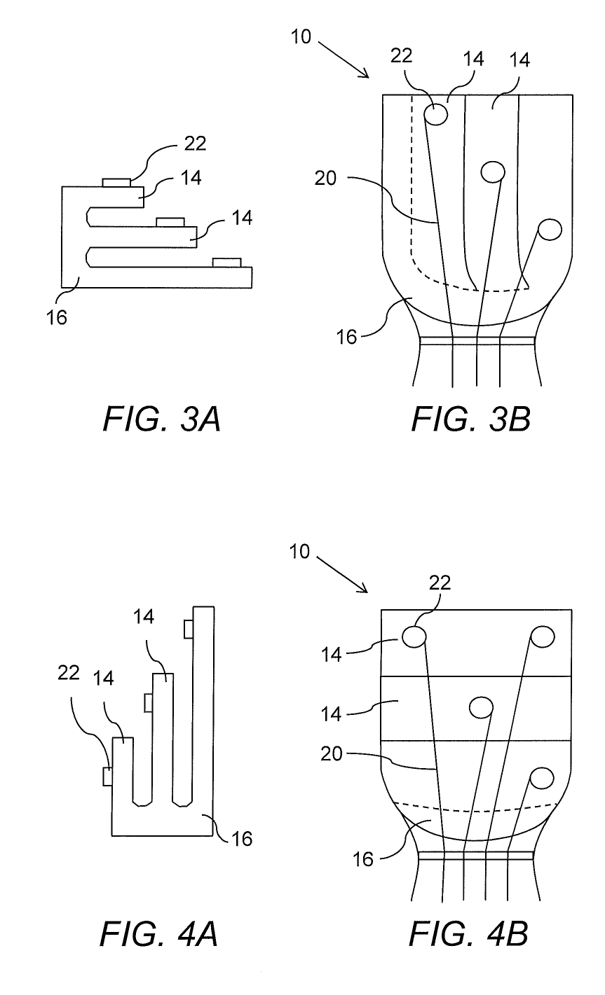

While FIGS. 1A and 1B depict slots 12 originating from the distal end of the headstock 10, any configuration is embraced by this invention. For example, when viewed from the front, the slots 12 could originate from one (FIG. 2A) or both (FIG. 2B) sides of the headstock 10. Alternatively, when viewed from the distal end, the slots 12 could originate from a side of the headstock 10 and create a series of stacked, independent arms 14 (see FIG. 3A). When viewed from the front (FIG. 3B), such an arrangement of stacked arms 14 would result in different levels for anchoring of the individual strings 20 to the headstock 10. In a similar configuration, a series of stacked independent arms 12 can be created when the slots 12 originate from the distal end of the headstock 10 (FIGS. 4A and 4B).

According to this invention, slots in the headstock create two or more independently resonating arms. Thus, in certain embodiments, the headstock has an even number of arms. However, in alternative embodiments, the headstock can have an odd number of arms. In specific embodiments, the headstock is composed of at least 2, 3, 4, 5, 6, or 7 independent arms. In particular embodiments, the headstock is composed of from 2 to 7, 3 to 7, 4 to 7, 5 to 7, or 6 to 7 independent arms. Illustrative headstocks with two arms are shown in FIGS. 1B, 2A, and 2B. Headstocks with three arms are illustrated in FIGS. 1A and 3-5. Headstocks with five and six arms are illustrated in FIGS. 6 and 7, respectively.

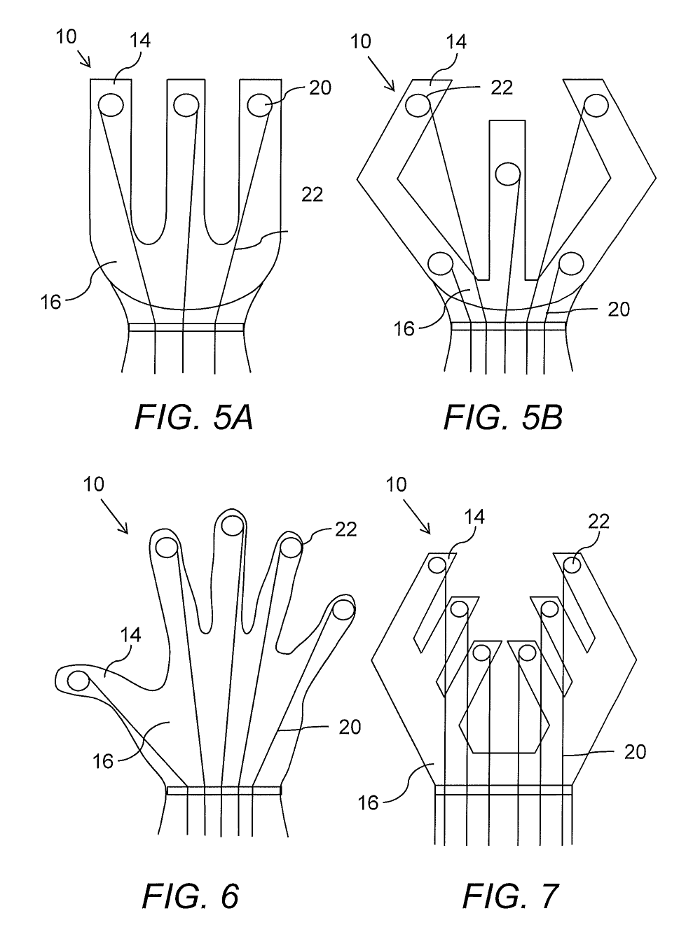

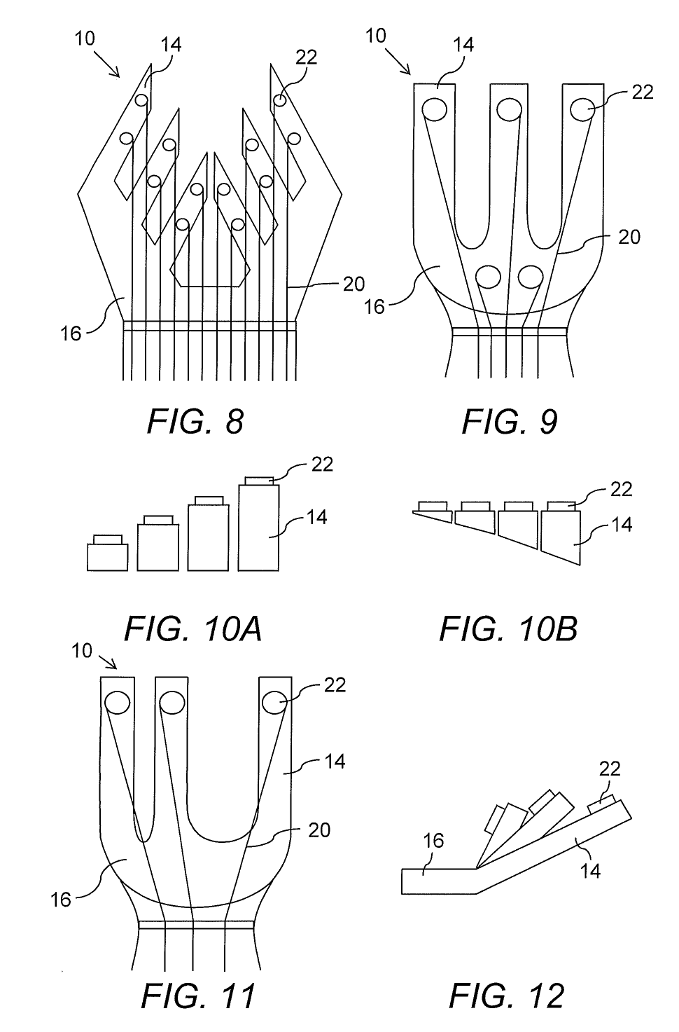

Depending on the stringed instrument to which the headstock is applied, the instant headstock can anchor between 3 and 12 strings, 4 and 12, 5 and 12, or 6 and 12 strings. In particular embodiments, the headstock of the invention can anchor at least 3, 4, 5, 6, 7, 8, 9, 10, 11, or 12 strings. While harp guitars can contain up to 42 strings, these instruments are also embraced by this invention because they generally contain multiple necks holding as many as 12 strings. Illustrative headstocks with three strings and hence three string anchor components are shown in FIGS. 2A, 2B, 3B, and 5A. A headstock with four string anchor components and strings is illustrated in FIG. 4B. Headstocks with five string anchor components and strings are illustrated in FIGS. 5B, 6 and 9, and headstocks with six and 12 string anchor components are illustrated in FIGS. 7 and 8, respectively.

The string anchor components of the present invention can be machine heads or tuning machines, or alternatively can function merely to hold the strings in place, wherein the tuners are not needed or are located in some other place on the body of the instrument. In particular embodiments, the string anchor components are tuning machines. In so far as the number of string anchor components is generally proportional to the number of strings, the headstock of the invention can contain between 3 and 12 string anchor components. Depending on the type and gauge of string, tonal quality to be achieved, and/or number of arms, the location of the string anchor components on the arms as well as the number of the string anchor components on each arm can be varied. For example, 0, 1, 2, 3, 4, 5 or more string anchor components can be attached or affixed to one arm. Moreover, in certain embodiments, one or more string anchor components are affixed to the base. By way of illustration, FIG. 5A depicts a headstock wherein the string anchor components on the arms are symmetrical in number and location. Alternatively, FIG. 1A depicts a headstock wherein the number of string anchor components are asymmetrical; one arm contains no string anchor components, one arm contains one string anchor component and one arm contains two string anchor components. In addition, FIGS. 1B and 3B depict headstocks wherein the location of the string anchor components are asymmetrical, e.g., in a diagonal. Moreover, FIG. 9 depicts a headstock 10 wherein two string anchor components 22 are affixed to base 16.

As indicated, one embodiment of this invention embraces a headstock with at least two slots. In alternative embodiments, this invention also embraces a headstock with a slot. Unless otherwise specified, a headstock with “a slot” is intended to include one, three, four, five, six, or more slots. In specific embodiments, a headstock with “a slot” embraces a headstock with 1 to 11, 2 to 11, 3 to 11, 4 to 11, 5 to 11, 6 to 11, 7 to 11, or 8 to 11 slots. In accordance with embodiments embracing a headstock with one slot, it is specifically contemplated that the arms of the headstock have at least one asymmetric feature as described herein. The number of slots inserted into the headstock can be dependent upon many variables including, but not limited, the stringed instrument to which the headstock is to be applied, the number of strings, the number of arms desired, the width of the slot, the location of the arms, the tonal quality to be achieved, aesthetics, space for logo, etc.

While particular embodiments of this invention embrace arms with identical features, i.e., symmetrical features, resonance and tonal quality can be further altered by independently modifying one or more features of each individual arm. Thus, according to another embodiment of this invention, the independent arms of the instant headstock have one or more asymmetrical features. For the purposes of the present invention, a feature is a distinctive aspect, quality, component, characteristic or material of the arm which can be altered. Features of the arms which can be varied to generate asymmetry include, but are not limited to, arm thickness (see, e.g., FIGS. 10A and 10B); arm width (see, e.g., FIG. 2B); arm length (see, e.g., FIGS. 3A, 4A, and 12); shape of the arm (see, e.g., FIGS. 5B and 10B); location of the arm on the base (see, e.g., FIG. 6), including spacing of the arms on the base (see, e.g., FIG. 11); orientation of the arm with respect to the base, e.g., changing the plane of the arm with respect to the base (see, e.g., FIG. 12); construction material of arms (e.g., laminate, solid material, composite material, etc.); location of string anchor components on the arms (see, e.g., FIGS. 1A, 1B, 3B, and 4B); number of string anchor components on the arms (see, e.g., FIGS. 1A and 4B); and construction material of string anchor components (e.g., quality and weight). Moreover, it is contemplated that additional mass can be added to one or more arms. It is contemplated that any one or combination of these features can be varied as per the Luthier's specific desires.

Materials which can be used in the construction of the instant headstock include, but are not limited to, woods, metals, synthetics, plastics, carbon fibers and combinations or laminates thereof. Woods include hardwoods such as ironwood, ebony, padauk, Indian rosewood, tarara, maple, mahogany and bamboo, as well as exotic woods and soft woods such as cedar and spruce. Metals include steel, aluminum, silver, gold, nickel, brass, and alloys thereof. Synthetics include polycarbonate resins, graphite epoxy and other high-tech composites.

For the purposes of the present invention, asymmetry of construction materials also includes varying the material and thickness. This can include varying the material and/or thickness of various layers of a laminate. Indeed, when a laminate is employed, it is contemplated that the laminate applied to the front of each arm can be different from the laminate applied to the back of each arm. As is conventional in the art, a laminate is a “sandwich” construction. By way of illustration, a laminate structure for an arm of the invention can be composed of a maple exterior, flanking a core of rosewood, wherein the laminates are bonded with an epoxy, glue, or other suitable bonding material.

Like the arms, the construction material of the string anchor component can be varied. This includes varying the quality, size, and/or weight of the string anchor component. Materials which can be used to vary the quality and/or weight of the string anchor components are the same as those used in the construction of the headstock and arms. For example, one arm of a headstock can contain tuning machines composed of silver, whereas another arm can contain tuning machines composed of aluminum.

Stringed instruments generally have three or more strings that produce a plurality of vibrations at a plurality of frequencies. The sound created by a single string may occasionally be composed of a single natural frequency, but nearly always, the sound is composed of several frequencies, with the first, or lowest, natural frequency usually being the dominant one. This lowest, first natural frequency is often referred to as the fundamental frequency. For example, a violin playing concert A pitch generates a sound spectrum composed of vibrations at many frequencies, but wherein most of the sound energy is concentrated at 440 Hz (i.e., the fundamental frequency of concert A). Put simply, it is the harmonics accompanying each note that give an instrument its characteristic sound, or tone. In general, the more harmonics that accompany each note, the more complex the tonal quality of the instrument, and the more pleasing the sound that is perceived by the listener. An advantage of the instant headstock is that the harmonics of one or more strings of an instrument can be altered, thereby independently enhancing the tonal quality of one more strings and hence the stringed instrument. Accordingly, the present invention also features a method for altering tonal quality of a stringed instrument by inserting a slot into a headstock of a stringed instrument thereby generating at least two arms in the headstock and attaching a string anchor component to at least one of the arms. In accordance with this method of the invention, a string anchored to the string anchor component will have modified harmonics thereby altering the tonal quality of the string and hence the instrument.

Upon reading the instant disclosure, it is to be understood that the invention is not limited in its application to the details of construction and to the arrangements of the components set forth in the description or illustrated in the drawings herein. The invention is capable of other embodiments and of being practiced and carried out in various ways. Also, it is to be understood that the phraseology and terminology employed herein are for the purpose of descriptions and should not be regarded as limiting.

The invention is described in greater detail by the following non-limiting examples.

### Example 1

### Measuring Changes in Resonance

Modes of string vibration and the resonance frequencies in the string vibration spectrum can be modeled by finite element analysis (FEA) or with more accuracy, by testing. A simple but effective test method for string resonance spectrum analysis is the impulse or “tap” test.

In this test, the tapping or striking of a string sharply with a stiff striker such as a small hammer or metal bar will cause the string to resonate. When tapped, it will resonate at all of its resonance frequencies within its range to generate its sound spectrum.

By using a vibration (sound) sensing device such as a low mass accelerometer attached directly to the string, or by measuring the air movement emanating from the string in free oscillations after it is struck, the resonance spectrum can be recorded and analyzed. Alternatively, the vibration can be obtained by recording information from the input/output jack of an electric stringed instrument. By providing the time-based resonance spectrum data to an instrument such as a spectrum analyzer and/or by performing a Fourier transform on the data, the data can be converted to frequency-based information. This information shows the resonance spectrum of the string.

What is claimed is:

1. A headstock comprising two or more slots therein thereby creating two or more independent arms, wherein at least one of the independent arms has one or more string anchor components.

2. The headstock of claim 1, wherein the string anchor components are tuning machines.

3. The headstock of claim 1, wherein the two or more independent arms have symmetrical features.

4. The headstock of claim 1, wherein the two or more independent arms have asymmetrical features.

5. The headstock of claim 3 or 4, wherein said features include one or more of:
(a) arm thickness,
(b) arm width,
(c) arm length,
(d) shape of arms,
(e) location of arms,
(f) orientation of arms,
(g) construction material of arms,
(h) location of string anchor components,
(i) number of string anchor components, and
(j) construction material of string anchor components.

6. A stringed instrument comprising the headstock of claim 1.

7. A headstock comprising a slot therein thereby creating two or more independent arms, wherein at least one of the independent arms has one or more string anchor components and said independent arms have asymmetrical features.

8. The headstock of claim 7, wherein the string anchor components are tuning machines.

9. The headstock of claim 7, wherein said features include one or more of:
(a) arm thickness,
(b) arm width,
(c) arm length,
(d) shape of arms,
(e) location of arms,
(f) orientation of arms,
(g) construction material of arms,
(h) location of string anchor components,
(i) number of string anchor components, and
(j) construction material of string anchor components.

10. A stringed instrument comprising the headstock of claim 7.

11. A method for altering tonal quality of a stringed instrument comprising inserting a slot into a headstock of a stringed instrument thereby generating at least two arms in the headstock and attaching a string anchor component to at least one of the arms thereby altering the tonal quality of the string and stringed instrument.
